(19) United States
(12) Patent Application Publication
(10) Pub. No.: US 2017/0300942 A1
(43) Pub. Date: Oct. 19, 2017

(54) DEVICE AND SYSTEM TO OBTAIN CUSTOMER FEEDBACK

(71) Applicant: Zeinolabedin Saadatfar, Richmond Hill (CA)

(72) Inventor: Zeinolabedin Saadatfar, Richmond Hill (CA)

(21) Appl. No.: 15/130,024

(22) Filed: Apr. 15, 2016

(51) Int. Cl. G06Q 30/02

(52) U.S. Cl. CPC G06Q 30/0203

(57) ABSTRACT

A device and method to obtain customer feedback about a service provider comprises of a simple device having a front side; with a plurality of input buttons, an electronic display screen to display a survey question; a computer storage to store a set of survey question related to a particular product or a service. The device further contains of three input areas for the customer to provide the rating of the services or products. The method includes providing a customer with a ratings device that is capable of receiving feedback by percentage rating through electrical or mechanical buttons, voice input through a microphone and writing input through a text entry box and transmit the initial information to the management department of a service provider.

### FIELD OF THE INVENTION

The present invention relates in general to customer feedback and in particular to a device and system for gathering customer feedback information.

### BACKGROUND OF THE INVENTION

Companies around the world care about their customer's satisfaction to improve their product or service. There are various ways to obtain customer feedback information and find out how satisfied the customers are. The most common way is customer feedback surveys that ask participants to rank the service provider. Studies show that service providers that score high in customer satisfaction grew faster than those, who scored average or low in customer satisfaction.

Customer feedback surveys still offer the best and most accurate way to measure satisfaction. However, most of the surveys provide long questions that take several minutes or more to fill out and ask lots of open-ended questions. Clients simply do not have the time for all that. Only 5-15% of the customers actually fill out the surveys and provide feedback.

Most of these surveys are online, which the customers usually forgot to leave their feedback except those are not satisfied with the product or the service.

A method and a device, which provides short and simple survey, can encourage more customers to provide their feedback about the service provider. By using simple surveys, the rate of the responses raises between 55-65%. That means the simple and fast method makes more customer to leave a feedback.

There are various methods to measure customer satisfaction, such as surveys, phone calls, emails, online questions, etc. A variety of software's to provide customer feedback measurements are also known. Organizations try to react to this feedback by improving their products and services to keep their customers satisfied. However, this can be challenging for an organization because of the many differences in customer feedback. But there is a need for a simple way to measure and collect valuable feedback of the customer to improve a service provider.

### SUMMARY OF THE INVENTION

The present invention provides a simple device and method for providing and obtaining customer feedback about a service provider and a specific product or service. The feedback device is a box having a front side; with a plurality of input buttons, an electronic display screen to display a survey question; a computer storage to store a set of survey question related to a particular product or a service.

Generally, the method is capable of receiving feedback and transmitting the initial information to the management department of a service provider. The device comprises of three rating inputs to encourage more people to leave their feedback. The more people participate in the survey, the reliable benchmark result can be achieved by the service provider about their service or product.

The first feedback input have eleven buttons rated from 0-100%, wherein each button represents the percentage of customer satisfaction. The input buttons may be electronic buttons or mechanical buttons. The second feedback input device is an electronic LED, LCD display or other such facility to allow a customer to input feedback. The third feedback input is a microphone for recording feedback from a participant.

The feedback device further includes a random question generator to randomly select at least one survey question from a set of survey questions and to display selected question on a display screen.

A computer program is provided to collect the customer responses to each survey question, generate a database for all responses received from the customer and analyze all responses. Customer feedback is then transmitted to the service provider through a communication system.

Customer feedback device can be mounted in a place that is in the view of the customer and is simply accessible. For example, the feedback device may be a tabletop customer feedback station, wall mount, floor mount, or mounted device on point of sale, point of transaction so customers can push the predetermined buttons or otherwise interact with the device to provide feedback for a specific product or service.

The customer feedback is then gathered and transmitted to the management department. Collection and transmission the customer feedback allows management to intervene with a provided service when necessary.

A plurality of feedback device can be installed in different departments and different places to collect more customer feedback. For example, in a store that supplies home hardware, the device can be placed on the tools department and the feedback question can be specifically related to the specific tools. In this case, the customer after visiting the tools section can provide a feedback based on the just visited place, the information that is gathered through this selective information is more reliable to help managers.

The present invention further having a scanning means to scan the barcode that is associated to the specific product. By scanning the barcode, the related survey displays on the device and the participant can response to the specific question and rate the product. The information is gathered based on each specific product with the other data such as date, time and the location of the device which the participant participate in the survey.

Once the customer has provided feedback to the feedback device the information may be provided to the management department, to determine if an action is needed to resolve the customer's low rating of the service or the product.

The feedbacks will be collected and stored in a data structure associated with a network device and transmitted to one of the notification devices of the responsible persons. At least one of the responsible persons may be a manager.

The notification device for the present invention may be one of a phone, a SMS message, an email, a web page alert, a fax, a pager or other such facility. The service provider may be a grocery store, a restaurant, a hardware store, an electronic store, or a fitness center.

The feedback may be recorded through a microphone on the feedback device and then communicated to a network system and the information is then delivered to the appropriate person.

The feedback device of the present invention further includes a text input box which is a touch screen display or an electronic paper, adapted to receive the feedback and the contact information of the customer.

The feedback includes a communication facility for transmitting the customer feedback to a data processing facility, wherein the data processing facility delivers a message to a responsible person associated with the service provider. In the system, the communication facility may include a cell phone transmission facility, a pager transmission facility, a Wi-Fi transmission facility, or a Bluetooth transmission facility.

It is the first objective of the present invention to provide a device to obtain the customer feedback, which is simple and fast, and encourage more customers to leave their feedback about the service provider.

It is the second objective of the present invention to provide a device to obtain the feedback of the customers based on percentage rating scale.

It is another objective of the present invention to follow customer satisfaction scores for individual clients and follow up directly from their feedback.

It is an object of the present invention to benchmark and improve customer satisfaction to give a service provider an additional insight that can guide business decisions.

It is another object of the present invention that prevents to limit the customer to answer only the generic feedback questions.

Other objects, features, and advantages of the present invention will be readily appreciated from the following description. The description makes reference to the accompanying drawings, which are provided for illustration of the preferred embodiment. However, such embodiments do not represent the full scope of the invention.

### BRIEF DESCRIPTION OF THE DRAWINGS

Embodiments herein will hereinafter be described in conjunction with the appended drawings provided to illustrate and not to limit the scope of the claims, wherein like designations denote like elements, and in which:

FIG. 1 illustrates a customer feedback device according to the present invention;

FIG. 2 is a perspective view of the customer feedback device according to the present invention;

FIG. 3 is a perspective view of the customer feedback device according to the present invention;

FIG. 4 is a top view of the usage of the present invention in a department store located in a plurality of places to collect survey data; and

FIG. 5 is a diagram of the method of customer feedback rating and processing system.

### DETAILED DESCRIPTION OF THE DRAWINGS

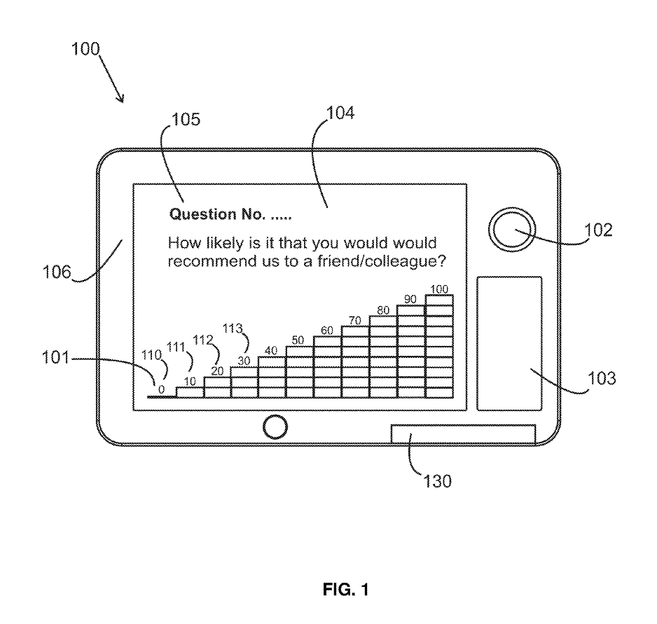

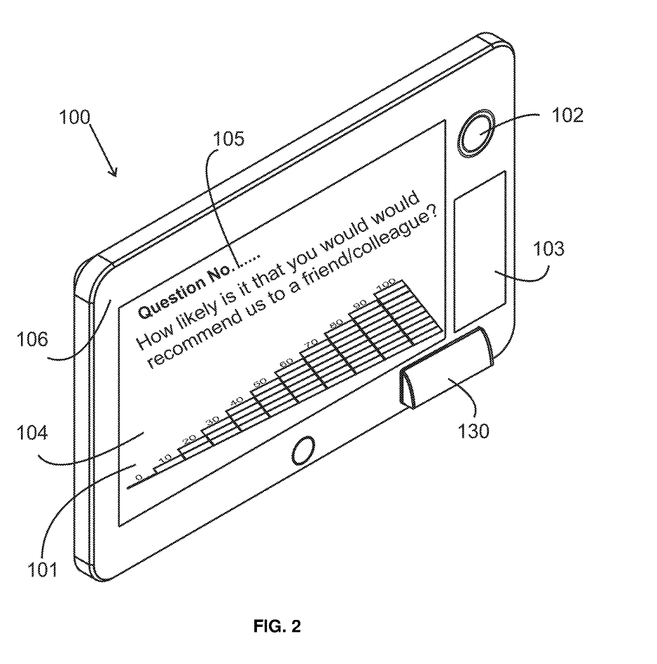

As shown in FIGS. 1 and 2, a device 100 for obtaining customer feedback comprising of a box having a front side 106; a plurality of input areas 101,102 and 103; an electronic display screen 104 to display a survey question 105; a computer storage to store a set of survey question related to a particular product or a service; a random question generator to randomly select at least one survey question from said set of survey questions and to display said selected question on said display screen 104; a computer program to collect the customer responses to each survey question, generate a database for all responses received, and analyze all responses received, and a communication system to transmit customer feedback to a service provider.

Again referring to FIG. 1, the feedback device 100 comprises of several input areas 101, 102 and 103. The first input area 101 contains of a plurality of input buttons 110-113 rating by percentage from 0%-100% buttons, wherein each button 110-113 representing the percentage of customer satisfaction; for the customer to provide the rating of the services or products. The input buttons 110-113 are arranged on the feedback device 100 to simply receive the customer's feedback.

The second input area 102 is a microphone to record the customer's feedback. As shown in FIGS. 1 and 2, customer provides direct feedback through a microphone. Direct feedback may be communicated between a customer and some other party or recorded, via a microphone 102.

The third input area 103 is a text input box to receive the customer feedback. The text input box may be a touch sensitive display such as a LCD display, electronic paper, a LED display or an electronic touch sensitive display. The input box 103 is able to display the messages in the message area and display inputs.

The third input area 103 may also include inputs such as a digital pen or touch screen, keyboard and the like, so that the customer can input any feedback to the service provider. This prevents to limit the customer to answer only the generic feedback questions.

The input system 101, 102 and 103 allows the service provider to vary the number of the inputs depending on the displayed messages or recorded messages or ranking button input on the feedback device.

The electronic display unit 104 further is used for setting up various parameters and/or inputting operational instructions 105. Optional daily items such as question about a new product or service are displayed and the customer can use the touch screen or the plurality of hard keys to respond.

As shown in FIGS. 1 and 2, the device 100 further having a scanning means 130 to scan the barcode in the product and display a random questionnaire from the related survey in the display screen 104. The information from each barcode are stored in the databases which are assigned to the specific products. The participant can response to the specific questions and rate the product. The information is gathered based on each specific product with the other data such as date, time and the location of the device which the participant participates in the survey. The bar code scanner-and-reader system includes a scanner unit 130 that scans the encoded information contained in a selected bar code and transmits the information to a reader unit. The bar code scanner-and-reader includes, a bar code information input portion that scans the encoded information of a selected item; an information processing portion that decodes the bar code information; and, an information transmitter-receiver that transmits the bar code information to the receiver unit. The information is stored in a database which is related to the specific product and a question will be randomly conducted and displayed on display.

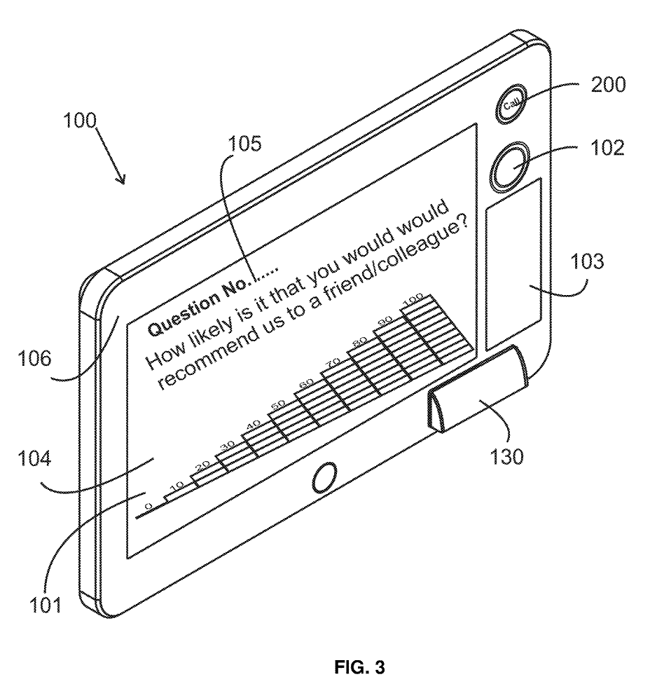

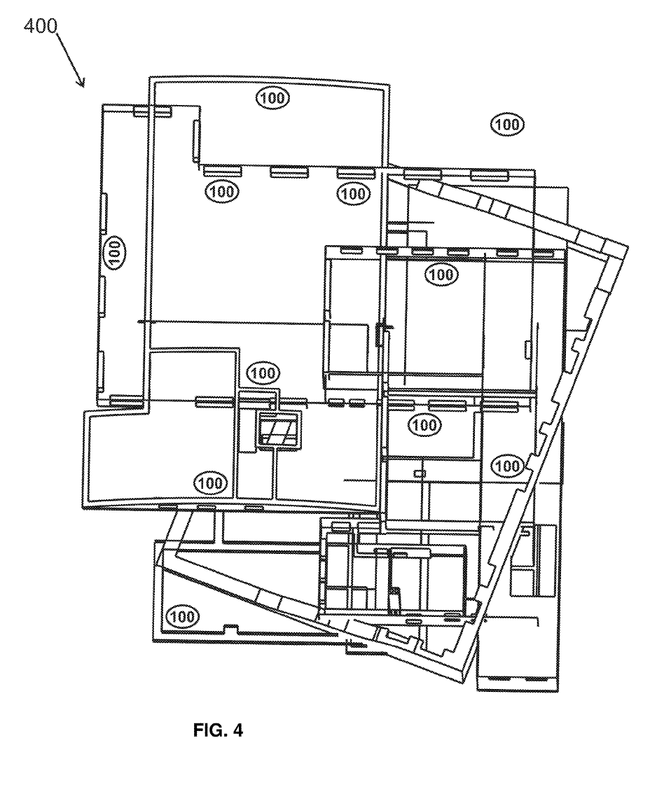

FIG. 4 shows an example of the usage of the present invention 100 in a department store 400. As shown in FIG. 3, the device 100 is located in a plurality of places to collect survey data. The device 100 can be placed near a display area for a new product to collect data related to the new product or ask a random question about the quality of a service at a specific point in the department store 400.

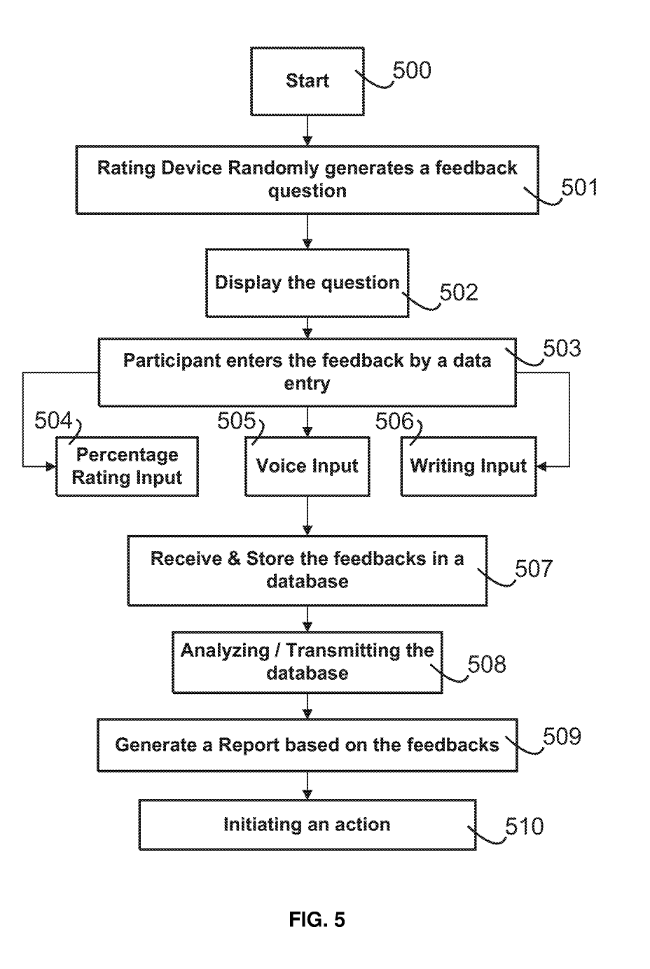

FIG. 5 is a diagram of a customer feedback system, according to the present invention. The customer may start to enter a rating 500 related to a service or product of a service provider. Said device randomly generates a feedback question 501 and the question displays on the display unit 502. The customer enters the feedback about a service or product, or respond to the specific question by a data entry 503. Customer's rating may contain a percentage rating input 504, a voice recorded input 505 or a written text input 506. The feedback device may receive the customer rating and store it in a data storage 507. The customer rating is directly passed to a computer device for storage or store in a cloud storage system which each device is connected. The customer feedback system may receive, format, organize, process, update, modify, and/or analyze the feedback received from the customers and transmit it 508.

The feedback may simply be passed to the management of the service provider and a report will be generated based on the feedbacks 509. An action will be made to respond to the customer depending on the inputs 510.

The customer feedback system may generate a message and communicated to any of the managers for which are responsible. The generated message in response to a customer rating may be sent to a phone, cell phone, PDA, computer monitor, electronic paper, by SMS message, and/or other communication facility of the manager.

The collected feedback data may be stored as a data structure on the feedback device or may be directly transmitted from the feedback device using wireless communication devices.

According to FIG. 5 again specifically, customer can provide feedback by clicking on the preference button 504 to provide percentage rating or provide direct feedback 505 through the microphone. Direct feedback may be communicated between a customer, and some other party or recorded, via a microphone. Direct feedback may be provide via a writing text by entering text into a text entry box on the feedback device 506. In this case the customer may leave contact information. After a manager receives a feedback message, the manager may determine an action that needs to be taken. One advantage of the present feedback system is, that the manager may receive the customer rating within moments of the customer providing the feedback. For example if a customer is not satisfied with the services provided during his/her visit or have issues with personnel's behavior, he/she can leave a feedback through microphone or writing input. With a quick communication of the feedback, the manager may be able to talk to the customer and turn a bad customer experience to a good experience.

The management department will collect the customer feedback, via a phone, cell phone, PDA, computer monitor, by SMS message, and/or other communication facility of the manager. The collected feedback is then interpreted and analyzed for a prompt response. If the rating is poor and outside certain parameters of the service provider, the management department can provide the right action as soon as possible.

For example, if a customer gave a 70-100%, the rating might consider the service or product are OK. But if the rating shows a 30-50%, it means the management department must take an action. A method of collecting customer feedback requires randomly displaying survey questions each at a time for customers and receiving the rating and continuing the steps until a predetermined number of rating are collected. After collecting customer responses to each survey question, a database will be generated for all responses and analyzed all responses and communicated feedback to the service provider.

Management department is able to contact individual customers, who left their contact information through their voice or written feedback through. Management can respond to the unhappy customers and take a prompt action to prevent any cancelation of a service. Each manager in the management department may have a unique message to alert the manager of a certain customer rating.

The feedback device 100 may also be available at the point of sale. The feedback device 100 may also be placed in a plurality of other locations that a service provider may wish to gather customer input. The feedback device 100 may also be made as a weather tight device that may allow the feedback device 100 to be placed outdoors. For example, an outdoors feedback device 100 may be able to receive customer feedback a fast food drive through for customers to rate the drive through service. The device may be made as a device to stand in the middle of a table.

In another embodiment of the present invention as shown in FIG. 3, the feedback device 100 further has a call key 200 that may use as a request to talk with a person in a store, to ask a question. When the call key 200 pushes by the customer, a location indicator in the system shows the exact location of the customer in the store, and the system automatically requests a help for the customer. A person will send to the location to answer to the customer questions.

The foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

With respect to the above description, it is to be realized that the optimum relationships for the parts of the invention in regard to size, shape, form, materials, function and manner of operation, assembly and use are deemed readily apparent and obvious to those skilled in the art, and all equivalent relationships to those illustrated in the drawings and described in the specification are intended to be encompassed by the present invention.

What is claimed is:

1. A device for obtaining a customer feedback, comprising:
a. a box having a front side;
b. an electronic display screen on said box to display a survey question;
c. a computer installed inside said box to store a set of survey questions related to a particular product or a service;
d. a random question generator installed in said computer to randomly select at least one survey question from said set of survey questions and to display said selected question on said display screen;
e. a plurality of input buttons on said box, each button marked to show a predefined percentage of a customer satisfaction in response to said question;
f. a computer program to collect the customer responses to each survey question, generate a database for all responses received, and analyze all responses received, and
g. a communication system to transmit customer feedback to a service provider.

2. The customer feedback device of claim 1, further having a customer input box to let a customer to write his/her own comment.

3. The customer feedback device of claim 1, further having a microphone for recording feedback.

4. The customer feedback device of claim 2, wherein said text input box being a touch screen, or an electronic paper adapted to receive the feedback and the contact information of the customer.

5. The customer feedback device of claim 1, wherein said display screen is a LCD display or LED display or other such facility, to display selected feedback question.

6. The customer feedback device of claim 1, wherein said input buttons may be electronic buttons or mechanical buttons.

7. The customer feedback device of claim 1, wherein said device being a tabletop station or a wall mount or a floor mount station.

8. The customer feedback device of claim 1, wherein said communication system is wired or wireless.

9. The customer feedback device of claim 1, wherein said communication system may include any one of the following: a phone, a cell phone, a PDA, a computer monitor, an electronic paper, SMS message.

10. A method of collecting customer feedback comprising steps of:
a. randomly displaying a first survey question on a survey device;
b. receiving a first rating for said first survey question from a first customer;
c. randomly displaying a second survey question on the survey device;
d. receiving a second rating for said second survey question from a second customer;
e. continuing steps a, b, c, and d until a predetermined number of ratings are collected, and
f. collecting the customer responses to each survey question, generating a database for all responses received, and analyzing all responses received, and communicating feedback to a service provider.
